(19) United States
(12) Patent Application Publication
(10) Pub. No.: US 2026/0338326 A1
(43) Pub. Date: Oct. 29, 2026

(54) STORAGE CONTAINER AND METHOD

(71) Applicant: LINDE GMBH, Pullach (DE)

(72) Inventors: Thomas HOFMEISTER, Pullach (DE); Heinz POSSELT, Pullach (DE); Harald ZENZ, Pullach (DE)

(21) Appl. No.: 19/123,100

(22) PCT Filed: Oct. 26, 2023
(86) PCT No.: PCT/EP2023/025448

§ 371 Date: Apr. 22, 2025

(30) Foreign Application Priority Data
Oct. 28, 2022 (EP) 22020524.9

(51) Int. Cl. F17C 1/12; F17C 7/04

(52) U.S. Cl. CPC F17C 1/12; F17C 7/04; F17C 2203/032; F17C 2203/0629; F17C 2205/0323; F17C 2205/0352; F17C 2221/012; F17C 2223/0161; F17C 2227/0327

(57) ABSTRACT

A storage container for storing a cryogen, with an inner container for receiving the cryogen a latent heat store for receiving a phase-change material, and a discharge line for removing the cryogen from the inner container, wherein the discharge line is operatively connected to the latent heat store in such a way that cryogen received in the discharge line exchanges heat with the phase-change material, and wherein the latent heat store can be fluidically connected to an environment of the storage container exclusively with the aid of a blow-off line.

### DESCRIPTION

The invention relates to a storage container for storing a cryogen and a method for operating such a storage container.

The applicant is aware of company-internal double-walled storage containers for liquid hydrogen which have an outer container and an inner container arranged within the outer container for holding the liquid hydrogen. A gap provided between the inner container and the outer container is subjected to a vacuum. The gap can be at least partially filled with an insulating material.

For the use of such a storage container in a maritime environment, it may be necessary for the storage container in the event of a malfunction to achieve a holding time of 15 days at maximum filling starting from the operating pressure. This means that during this time, a maximum permissible pressure within the inner container must not be exceeded, and no hydrogen may escape from the storage container.

Depending on the heat input and the thermodynamic equilibrium temperature of the stored liquid hydrogen, the storage container can currently only be filled to a certain extent with liquid hydrogen due to the holding time requirement. Under currently typical conditions, sometimes only 70% to 80% of a geometric container volume of the storage container can be used for storing the liquid hydrogen. This must be improved.

Against this background, it is an object of the present invention to provide an improved storage container.

Accordingly, a storage vessel for storing a cryogen is proposed. The storage container comprises an inner container for receiving the cryogen, a latent heat store for receiving a phase-change material, and a discharge line for removing the cryogen from the inner container, wherein the discharge line is operatively connected to the latent heat store in such a way that cryogen received in the discharge line exchanges heat with the phase-change material, and wherein the latent heat store can be fluidically connected to an environment of the storage container exclusively with the aid of a blow-off line.

Due to the latent heat store being provided, the phase change enthalpy of the phase-change material during a phase change from solid to liquid can be used, for example, to cool a shield enclosing the inner container or other components of the storage container. As a result, the holding time of the storage container for the cryogen can be extended. In particular, emergency cooling can be implemented. Furthermore, a higher filling level of the inner container with the cryogen can also be achieved.

The storage container is also in particular suitable for transporting the cryogen. For this reason, the storage container can also be called a transport container. The storage container is preferably at least double-walled and comprises, in addition to the inner container, an outer container enclosing the inner container. The storage container can therefore also be called a double-walled storage container. The storage container can be part of a vehicle, in particular a watercraft. In this case, the storage container is suitable for mobile applications. However, the storage container can also be used stationary, for example in building technology.

The discharge line leads from the storage container, for example to a consumer in the form of a fuel cell. The consumer can, for example, power an electric motor that drives a ship's propeller. The liquid cryogen can be vaporized upstream of the consumer so that gaseous cryogen is supplied to the consumer at a suitable supply pressure and a suitable supply temperature.

The cryogen can be liquid hydrogen. Since the storage container is preferably suitable for holding liquid hydrogen, the storage container can also be called a hydrogen storage container or a hydrogen storage tank. The term “cryogen” can in the present case be exchanged for the term “hydrogen” and vice versa. However, the cryogen can also be liquid helium, liquid neon, or the like.

The cryogen is held in the inner container. As long as the cryogen is in the two-phase region, a gas zone with vaporized cryogen and a liquid zone with liquid cryogen can be provided in the inner container. After entering the inner container, the cryogen therefore has two phases with different aggregate states, namely, liquid and gaseous. That is to say, a phase boundary between the liquid cryogen and the gaseous cryogen is present in the inner container. Only the liquid cryogen is removed from the inner container via the discharge line. An end of the discharge line located on or in the inner container is arranged in or at the lower part of the inner container in the direction of gravity. Preferably, this end is located in or at the lower third of the inner container, particularly preferably in or at the lower sixth of the inner container. Particularly preferably, this end of the discharge line is spaced up to 30 mm, more particularly preferably up to 20 mm, from the lowest point of the inner container in the direction of gravity.

The storage container is preferably rotationally symmetrical with respect to an axis of symmetry or center axis. Accordingly, the inner container and the outer container can also be constructed rotationally symmetrical to the center axis. The storage container is preferably arranged such that the center axis is perpendicular to the direction of gravity. This means that the storage container is arranged horizontally. However, the storage container can also be arranged vertically. In this case, the center axis is oriented parallel to the direction of gravity.

The inner container is preferably cylindrical in shape. The inner container has in particular a tubular or cylindrical base section which can have a rotationally symmetrical design with respect to the center axis. The base section of the inner container is closed at each end by two outwardly curved cover sections. However, this is not necessarily the case. The cover sections can also be designed differently. The inner container can also be called an inner tank.

The latent heat store can also be called a phase-change store or PCM store (phase-change material). In this case, a “latent heat store” is to be understood in particular as a special type of heat store that stores a large part of the thermal energy supplied thereto in the form of latent heat, for example for a phase change from solid to liquid.

In particular, a phase-change material is used which has a melting point that is above a storage and/or transport temperature of the cryogen held in the inner container.

Nitrogen is preferably used as the phase-change material. For this reason, the term “phase-change material” can be replaced by the term “nitrogen” in the present case. However, argon, for example, can also be used as the phase-change material.

The phase-change material can be part of the latent heat store and therefore also part of the storage container. The phase-change material can undergo a phase transition from solid to liquid as well as from liquid to gaseous and vice versa. Preferably, during normal operation of the storage container, during which the cryogen is removed from the storage container, only a phase change between solid and liquid or between liquid and solid is provided. The phase-change material absorbs heat during the phase change from solid to liquid and releases heat during the phase change from liquid to solid. During the phase change from liquid to solid, the heat required for this can be extracted from a shield surrounding the inner container, which is thereby cooled. This shield can be part of the storage container.

In particular, the discharge line is connected to the latent heat store in a heat-conducting manner so that the cryogen flowing through the discharge line can extract heat from the phase-change material, whereby the phase-change material undergoes a phase change from liquid to solid. For example, if no cryogen is removed from the storage container for a short time, the phase-change material undergoes a phase change from solid to liquid. In so doing, the phase-change material absorbs heat which can be used in particular to cool the inner container, for example with the aid of the aforementioned shield.

The discharge line can, for example, be connected to the latent heat store on the outside. However, the discharge line can also be routed directly through the latent heat store. In the present case, the fact that the discharge line is “actively connected” to the latent heat store is to be understood in particular to mean that the discharge line can be in heat exchange with the latent heat store in any manner so that heat can be transferred from the latent heat store to the discharge line and vice versa.

In the aforementioned normal operation of the storage container, the latent heat store forms a closed system that is not connected to the environment. In this case, “normal operation” means that the cryogen is removed from the storage container and, if necessary, the removal of the cryogen is briefly interrupted. If the removal of cryogen is interrupted for a longer period of time, for example in the event of a malfunction of the storage container, the latent heat store can be fluidically connected to the environment with the aid of the blow-off line, wherein gaseous phase-change material is released into the environment.

The fact that the latent heat store can be connected to the environment “exclusively” or “only” with the aid of the blow-off line means in this case that, apart from the blow-off line, no further fluidic connection between the latent heat store and the environment exists or can be established.

However, a fluidic connection of the latent heat store with the environment does not take place during normal operation of the latent heat store. Only in the event of a malfunction is the latent heat store fluidically connected to the environment with the aid of the blow-off line. In this case, the fact that the latent heat store is “fluidically connected” to the environment is to be understood in particular to mean that the gaseous phase-change material from the latent heat store can be released into the environment via the blow-off line. For example, the blow-off line releases the gaseous phase-change material into the environment when a maximum permissible pressure is exceeded in the latent heat store.

According to one embodiment, the discharge line is routed through the latent heat store.

The latent heat store can, for example, have a cylindrical geometry. The discharge line can be routed through the latent heat store several times. For this purpose, the discharge line can, for example, be constructed in a meandering shape. However, the discharge line can also be screw-shaped or helical. However, the discharge line can also be routed straight through the latent heat store. Alternatively, the discharge line can also be connected externally to the latent heat store.

According to a further embodiment, a heat exchanger is attached to the discharge line and is arranged within the latent heat store.

The heat exchanger is preferably plate-shaped. The heat exchanger can, for example, be soldered or welded to the blow-off line. The heat exchanger is made of a highly thermally conductive material such as aluminum or copper. The heat exchanger can have multiple heat exchanger plates placed within the latent heat store.

According to a further embodiment, the latent heat store is at least partially filled with a heat-conducting, fluid-permeable material structure. This can be a woven, knitted or knitted fabric, which is preferably metallic. The material structure can have metal threads or metal wires. Preferably it is metal wool. Alternatively, the material structure can also comprise smooth and/or structured metal plates and/or metal foils. The material structure can be made of aluminum, an aluminum alloy, copper or a copper alloy.

In particular, the material structure can be connected to the heat exchanger. The material structure is impregnated with the phase-change material. This results in a particularly good contact between the phase-change material and the material structure and therefore also with the heat exchanger. Preferably, the material structure can be or comprise copper wool, copper alloy wool, aluminum wool and/or aluminum alloy wool. The highly thermally conductive material structure ensures good heat transfer between the heat exchanger and the solid phase-change material.

According to a further embodiment, the blow-off line has a blow-off valve for blowing off the phase-change material into the environment.

The blow-off valve preferably opens at a predetermined pressure. For example, a maximum permissible pressure is specified for the latent heat store. As soon as this maximum permissible pressure is reached during evaporation of the phase-change material, the blow-off valve opens, and the gaseous phase-change material is blown off into the environment.

According to a further embodiment, the storage container further has a shield which encloses the inner container and the latent heat store, wherein the latent heat store is thermally conductively connected to the shield.

The latent heat store can be part of the shield or vice versa. The shield is preferably made of a highly thermally conductive material such as aluminum or copper. In particular, the shield has a tubular base section which can have rotationally symmetrical design with respect to the center axis. The ends of the shield are closed with the aid of two cover sections. The cover sections can preferably be curved outwards with respect to the base section. The inner container and the latent heat store are arranged within this shield. The latent heat store can be thermally connected to the shield, for example, with the aid of one heat conducting element or a plurality of heat conducting elements. The phase-change material can therefore remove heat from the shield via the heat conducting element or heat conducting elements so that the shield is cooled.

According to a further embodiment, the latent heat store is arranged between a cover section of the inner container and a cover section of the shield.

As previously mentioned, the inner container has two cover sections, in particular a first cover section and a second cover section. Accordingly, the shield also has two cover sections, in particular a first cover section and a second cover section. The latent heat store is particularly preferably arranged between the second cover section of the inner container and the second cover section of the shield, viewed along the center axis.

According to a further embodiment, the blow-off line is thermally conductively connected to the shield.

This improves heat transfer between the blow-off line and the shield. The cold gaseous phase-change material can remove heat from the shield, thereby cooling it further. For example, the blow-off line is soldered or welded to the shield. The blow-off line can be arranged inside the shield or outside the shield. In this case, “inside” the shield means facing the inner container. “Outside” the shield means facing away from the inner container.

According to a further embodiment, the blow-off line runs in a helical manner around the shield on the inside or outside.

This extends the blow-off line, which improves the heat transfer from the blown-off gaseous phase-change material to the shield.

According to a further embodiment, the storage container further has an outer container which encloses the shield.

The outer container has in particular a tubular base section which can have a rotationally symmetrical design with respect to the center axis. The outer container is closed at the end with the aid of two cover sections, in particular with the aid of a first cover section and a second cover section. The cover sections are preferably curved outwards with respect to the base section. The outer container encloses the shield which in turn encloses the inner container and the latent heat store. The shield is therefore arranged completely inside the outer container.

According to a further embodiment, the storage container further comprises a multi-layer insulation element which at least partially fills a gap provided between the inner container and the outer container.

The insulation element can also be called an insulating element. The insulation element serves for the thermal insulation of the inner tank. In particular, the aforementioned shield is arranged in the gap. The gap can be completely filled with the insulation element and the shield. Alternatively, the gap can also only be partially filled with the insulation element. The insulation element preferably encloses both the base section and the cover sections of the inner container. Preferably, the insulation element comprises a plurality of layers. In particular, the insulation element is a so-called multilayer insulation (MLI). The insulation element comprises a plurality of alternately arranged layers of perforated and embossed aluminum foil as a reflector and glass paper as spacers between adjacent aluminum foils. The glass paper can be perforated and/or punched.

According to another embodiment, the shield is embedded in the insulation element.

This means in particular that layers of aluminum foil and glass paper can be provided inside and outside the shield. In particular, the shield is embedded in outer layers of the insulation element. “Outside” here is to be understood as in the region or in the direction of the outer container.

Furthermore, a method for operating such a storage container for storing a cryogen is proposed. The method comprises the following steps: a) removing liquid cryogen from the storage container, wherein during step a), a phase-change material held in a latent heat store of the storage container undergoes a phase transition from liquid to solid by transferring heat from the phase-change material to the liquid cryogen, or wherein the phase-change material remains solid during step a); step b) ending step a), wherein the phase-change material undergoes a phase transition from solid to liquid, and step c) fluidically separating the latent heat store from an environment of the storage container during steps a) and b).

In step a), in particular, a part of the liquid cryogen is removed from the storage container via the discharge line. During step a), the phase-change material held in the latent heat store undergoes a phase transition from liquid to solid by the heat being transferred from the phase-change material to the cryogen. In the case wherein the phase-change material is already solid, the phase-change material remains solid during step a). In this case, too, heat continues to be removed from the phase-change material. In step b), step a) is terminated. This means that, at least for a short time, cryogen stops flowing through the discharge line. Step b) can be carried out until all the phase-change material has melted. In particular, step b) can be carried out until a maximum permissible pressure as mentioned above is reached in the latent heat store. During step b), the phase-change material undergoes a phase transition from solid to liquid or remains in its aggregate state. Step c) is preferably carried out in parallel to steps a) and b). This means that during steps a) and b), the latent heat store is fluidically separated from the environment of the storage container according to step c). This means that the blow-off valve is always closed during steps a) to c). The fluidic separation of the latent heat store from the environment only ceases when the phase-change material is at least partially gaseous and the maximum permissible pressure in the latent heat store is exceeded. This can occur, for example, during a malfunction of the storage container in which no cryogen is removed from the inner container for an extended time. The gaseous phase-change material is then blown off into the environment via the blow-off line and the blow-off valve.

According to one embodiment, during step b), heat required for the phase transition is extracted from a shield enclosing an inner container of the storage container.

In particular, during step b), the heat required for the phase transition from solid to liquid is removed from the shield. This cools the shield.

According to a further embodiment, steps a) to c) are carried out during normal operation of the storage container, wherein a blow-off valve of the storage container is opened only in the event of a malfunction of the storage container, whereby gaseous phase-change material is blown off into the environment.

“Normal operation” of the storage container means that the liquid cryogen is being removed therefrom. However, normal operation can also involve a short-term interruption in the removal of liquid cryogen. The malfunction occurs when the phase-change material undergoes the phase transition from liquid to gaseous, and the pressure in the latent heat store rises above the maximum permissible pressure. This means that only in a malfunction is the latent heat store connected to the environment via the blow-off valve in order to blow off the gaseous phase-change material.

In the present case, “a(n)” is not necessarily to be understood as limiting to exactly one element. It is rather the case that a plurality of elements, such as two, three, or more, may also be provided. Any other numerical word used herein is also not to be understood as meaning an exact limitation to exactly the corresponding number of elements. Rather, numerical differences upwards or downwards are possible.

The embodiments and features described for the storage container apply correspondingly to the proposed method and vice versa.

Further possible implementations of the storage container and/or of the method also include not explicitly mentioned combinations of features or embodiments described above or below with respect to the exemplary embodiments. In this case, a person skilled in the art will also add individual aspects as improvements or additions to the relevant basic form of the storage exchanger and/or of the method.

Further advantageous embodiments of the storage container and/or of the method are the subject-matter of the subclaims and of the exemplary embodiments of the storage container and/or of the method described below. The storage tank and/or the method are explained below in more detail with reference to the accompanying figures based on preferred embodiments.

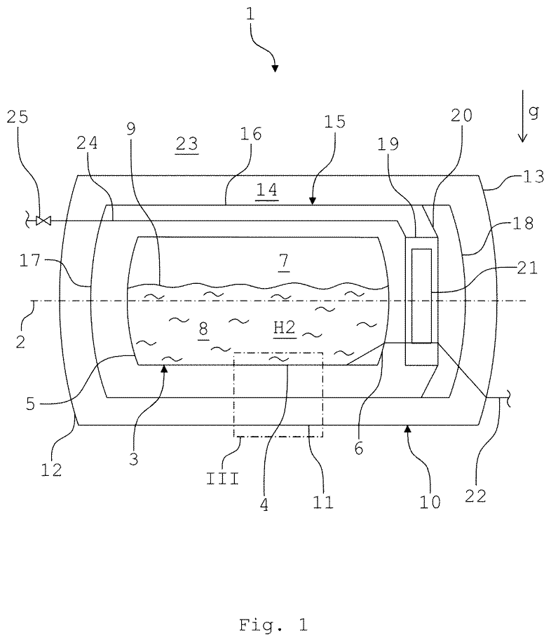

FIG. 1 shows a schematic sectional view of an embodiment of a storage vessel;

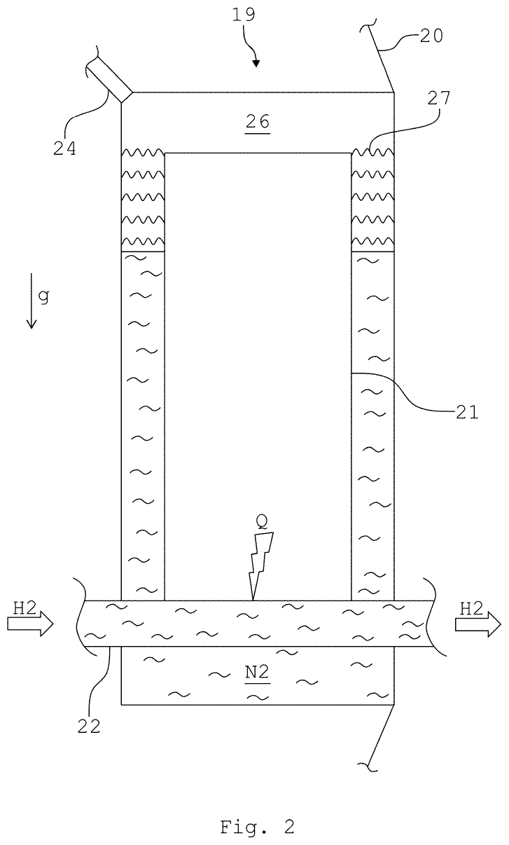

FIG. 2 shows a schematic sectional view of an embodiment of a latent heat store for the storage container according to FIG. 1;

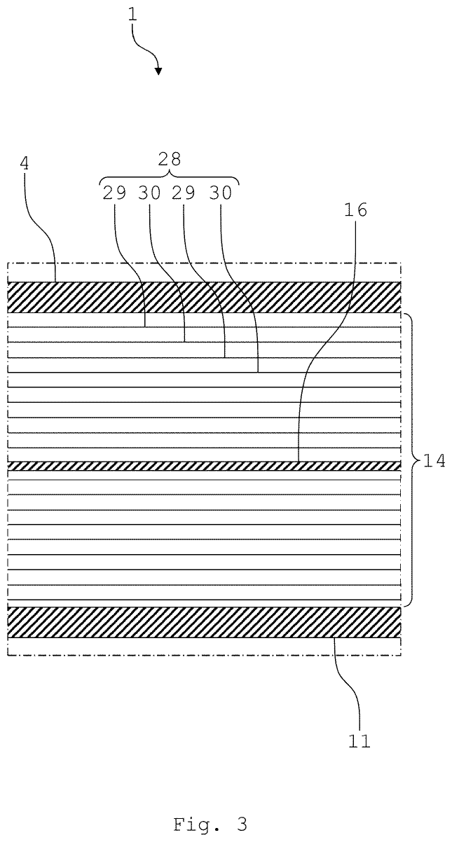

FIG. 3 Shows the Detailed View Iii According to FIG. 1; and

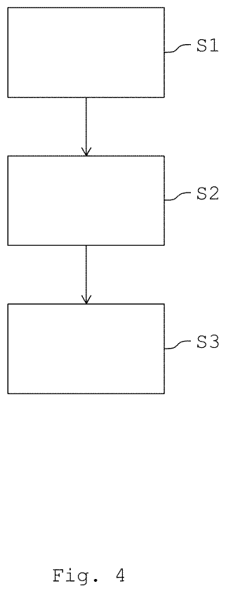

FIG. 4 shows a schematic block diagram of an embodiment of a method for operating the storage exchanger according to FIG. 1.

In the figures, the same or functionally equivalent elements have been provided with the same reference signs unless otherwise indicated.

FIG. 1 shows a schematic sectional view of an embodiment of a storage vessel 1.

The storage container 1 can also be called a storage tank. The storage container 1 is suitable for holding a cryogen H2. In this case, the cryogen H2 is hydrogen and is also called hydrogen below. The storage container 1 is preferably suitable for holding liquid hydrogen H2 (boiling point 1 bara: 20.268 K=−252.882 °C). The storage vessel 1 can therefore also be referred to as a hydrogen storage vessel or as a hydrogen storage tank.

However, the storage vessel 1 can also be used for other cryogenic liquids. An example of a cryogenic fluid or a cryogenic liquid, or in short a cryogen, is, in addition to the previously mentioned hydrogen H2, liquid helium He (boiling point 1 bara: 4.222 K=−268.928 °C).

The storage container 1 can be transport container. For example, liquid hydrogen H2 can be transported with the storage container 1. The storage container 1 can be part of a vehicle, in particular a watercraft. In this case, the storage container 1 is suitable for mobile applications. However, the storage container 1 can also be used stationary, for example in building technology.

For use of storage container 1 in a maritime environment, it is necessary for the storage container 1 to achieve a holding time of 15 days at maximum filling based on the operating pressure in the event of a malfunction. This means that during this time, a maximum permissible pressure within the inner container 3 must not be exceeded, and no hydrogen H2 may escape from the storage container 1.

Depending on the heat input and the thermodynamic equilibrium temperature of the stored liquid hydrogen H2, the storage container 1 can currently only be filled to a certain extent with liquid hydrogen H2 due to the holding time requirement. Under current typical conditions, sometimes only 70% to 80% of a geometric container volume of the storage container 1 can be used for the storage of liquid hydrogen H2. This must be improved.

The storage container 1 is rotationally symmetrical with respect to an axis of symmetry 2 or center axis 2. The center axis 2 is oriented in particular perpendicular to the direction of gravity g. The storage container 1 comprises a first container or inner container 3 which is also constructed rotationally symmetrically to the center axis 2. The inner container 3 comprises a tubular or cylindrical base section 4 which can have an also rotationally symmetrical design in relation to the center axis 2. In cross-section, the base section 4 can have a circular or approximately circular geometry.

The base section 4 is closed at both ends with the aid of a cover section 5, 6. The cover sections 5, 6 are domed. A first cover sections 5 and a second cover section 6 are domed in opposite directions so that the two cover sections 5, 6 are domed outward in relation to the base section 4. The inner container 3 is fluid-tight, in particular gas-tight. The inner container 3 can be made of stainless steel.

The liquid hydrogen H2 is held in the inner container 3. As long as the hydrogen H2 is in the two-phase region, a gas zone 7 with vaporized hydrogen H2 and a liquid zone 8 with liquid hydrogen H2 can be provided in the inner tank 3. After entering the inner tank 3, the hydrogen H2 therefore has two phases with different aggregate states, namely, liquid and gaseous. That is to say, in the inner tank 3 there is a phase boundary 9 between the liquid hydrogen H2 and the gaseous hydrogen H2.

The inner container 3 is arranged completely within a second container or outer container 10. The storage container 1 is therefore double-walled. The outer container 10 is also rotationally symmetrical in relation to center axis 2. The outer container 10, like the inner container 3, comprises a tubular or cylindrical base section 11 which is rotationally symmetrical in relation to the center axis 2. In cross-section, the base section 11 can have a circular or approximately circular geometry.

The base section 11 is closed off at the ends in each case by a cover section 12, 13. In particular, a first cover section 12 and a second cover section 13 are provided. The cover sections 12, 13 are domed in opposite directions so that the cover sections 12, 13 are domed outward in relation to the base section 11. The outer container 10 is fluid-tight, in particular gas-tight. The outer container 10 can also be made of stainless steel, for example.

A gap 14 completely surrounding or encompassing the inner container 3 is provided between the inner container 3 and the outer container 10. The gap 14 is subjected to a vacuum. In the present case, a “vacuum” is understood to mean a pressure of less than 300 mbar, preferably less than 10⁻³ mbar, more preferably less than 10-7 mbar. The storage container 1 is therefore vacuum.-insulated. The fact that the gap 14 completely “encompasses” or “encases” the inner container 3 means in the present case that the gap 14, on the one hand, runs completely around the base section 4 and, on the other hand, is also provided between the two cover sections 5, 12 as well as between the two cover sections 6, 13.

A screen or shield 15, in particular a so-called soft shield, is provided between the inner container 3 and the outer container 10. The shield 15 is therefore placed in the gap 14. The shield 15 is made of a highly thermally conductive material such as copper or aluminum. The shield 15 is preferably fluid-permeable, in particular gas-permeable. The shield 15 has a cylindrical base section 16 which is rotationally symmetrical to the center axis 2. The base section 16 is closed at the ends with the aid of a first cover section 17 and a second cover section 18.

A latent heat store 19 is placed within the shield 15. In the orientation in FIG. 1, the latent heat store 19 is placed next to the inner container 3. In particular, the latent heat store 19 is arranged between the cover sections 6, 18. The latent heat store 19 is at least partially filled with a phase-change material N2 (PCM) as will be explained below. The phase-change material N2 in the present case is nitrogen. However, the phase-change material N2 can also be argon, for example.

In the following, it is assumed that the phase-change material N2 is nitrogen. For this reason, the phase-change material N2 is called nitrogen in the following. The latent heat store 19 is connected to the shield 15, in particular to the base section 16 of the shield 15, via a heat conducting element 20 running around the center axis 2. The heat conducting element 20 can be disk-shaped.

A heat exchanger 21 is arranged within the latent heat store 19. The heat exchanger 21 is thermally conductively connected to a discharge line 22 which opens into the inner container 3 below the phase boundary 9, is guided through the latent heat store 19, and is guided through the shield 15 and the outer container 10 into an environment 23 of the storage container 1.

The heat exchanger 21 is connected to the discharge line 22 so that the discharge line 22 can transfer heat to the heat exchanger 21 or vice versa. The heat exchanger 21 can be a metal plate welded or soldered to the discharge line 22, in particular an aluminum plate or a copper plate. The heat exchanger 21 can also be constructed from a plurality of such metal plates.

A blow-off line 24 with a blow-off valve 25 leads out of the latent heat store 19. The blow-off line 24 can be routed within the shield 15. The blow-off line 24 can be thermally conductively connected to the shield 15. The blow-off line 24 can run in a screw-shaped or helical manner around the center axis 2 and be fastened to the inside or outside of the shield 15. The blow-off valve 25 can release vaporized nitrogen N2 into the environment 23.

FIG. 2 shows a schematic sectional view of an embodiment of latent heat store 19 as mentioned above.

The latent heat store 19 acts as a thermal buffer of the storage container 1. The latent heat store 19 encloses an interior space 26 in which the heat exchanger 21 is held which is in contact with solid nitrogen N2. The latent heat store 19 can be completely or partially filled with the solid nitrogen N2. The interior space 26 is at least partially or completely filled with a heat-conducting, fluid-permeable material structure, such as a knitted fabric 27 in this embodiment.

The knitted fabric 27 can be made of aluminum and/or copper threads. In particular, the knitted fabric 27 can be copper wool and/or aluminum wool. The knitted fabric 27 is connected to the heat exchanger 21 in a heat-conducting manner. The knitted fabric 27 is impregnated with nitrogen N2. The highly heat-conductive knitted fabric 27 ensures good heat transfer between the heat exchanger 21 and the solid nitrogen N2.

FIG. 3 shows the detailed view III of the storage container 1 according to FIG. 1.

A thermal insulation element or insulating element 28 which completely encompasses or surrounds the inner container 3 is provided in the gap 14. That is to say, the insulation element 28 encloses not only the base section 4 but also the cover sections 5, 6 of the inner container 3. The insulation element 28 serves for thermal insulation. The insulation element 28 is multilayer. This means that the insulation element 28 comprises a plurality of layers. The insulation element 28 can therefore also be called a multilayer insulation element or a multilayer thermal insulation element.

In particular, the insulation element 28 is a so-called multilayer insulation (MLI). The insulation layer 28 comprises a plurality of alternately arranged layers of perforated and embossed aluminum foil 29 as a reflector and glass paper 30 as spacers between adjacent aluminum foils 29. The glass paper 30 can be perforated and/or punched.

In FIG. 3, only two layers of aluminum foil 29 and two layers of glass paper 30 are provided with a reference sign. The glass paper 30 acts as a spacer between two adjacent aluminum foils 29, whereby the insulation element 28 can be subjected to the vacuum prevailing in the gap 14. The insulation element 28 lies on the outside of the inner container 3.

The insulation element 28 can fill the gap 14 partially or—as shown in FIG. 3—completely. The shield 15 can be embedded in the insulation element 28. This means that layers of aluminum foil 29 and glass paper 30 can be provided inside and outside the shield 15. In particular, the shield 15 is embedded in outer layers of the insulation element 28. “Outside” is to be understood here as within the region of the outer container 10.

The functionality of the storage container 1 is explained below. During normal operation of the storage container 1, a basically constant withdrawal of liquid hydrogen H2 from the inner container 3 takes place via the discharge line 22. When the liquid hydrogen H2 is passed through the latent heat store 19, it extracts heat Q from the nitrogen N2 via the heat exchanger 21 and the knitted fabric 27.

The nitrogen N2, in the case of it being liquid, undergoes a phase transition from liquid to solid. In the case of the nitrogen N2 already being solid, it is kept in the solid state. This means that the nitrogen N2 held in the latent heat store 19 is solid during normal operation of the storage container 1. The latent heat store 19 is at least partially thermally separated from the inner container 3.

If there is briefly no longer any withdrawal of liquid hydrogen H2, the solid nitrogen N2 will melt with a moderate increase in pressure in the latent heat store 19. When the solid nitrogen N2 melts, it removes heat Q from the shield 15 via the heat conducting element 20. Because the latent heat store 19 is connected to the shield 15 via the heat conducting element 20, the shield 15 is cooled down.

If the discharge of liquid hydrogen H2 is subsequently resumed, a reverse phase transition of the nitrogen N2 from liquid to solid occurs, since the liquid hydrogen H2 flowing through the discharge line 22 extracts heat Q from the liquid nitrogen N2. During normal operation of the storage container 1, the system is therefore closed.

If no more liquid hydrogen H2 is discharged over a longer period of time, the solid nitrogen N2 will melt, begin to boil and eventually evaporate. The gaseous nitrogen N2 can then be blown off into the environment 23 via the blow-off line 24 and the blow-off valve 25. As previously mentioned, the blow-off line 24 can run in a helical manner around the shield 15, whereby the cold and gaseous nitrogen N2 further removes heat Q from the shield 15.

In normal operation, the phase transition of the nitrogen N2 from solid to liquid and vice versa prevents a loss of nitrogen N2 via the blow-off line 24 and the blow-off valve 25 and/or that a maximum permissible pressure within the latent heat store 19 has to be selected too high. During a malfunction the heat input into the inner container 3 is significantly reduced by the shield 15 cooled by nitrogen N2. This increases the holding time of the hydrogen H2.

During normal operation of the storage container 1, the latent heat store 19 together with the heat exchanger 21 therefore form a closed system in which a phase transition from solid to liquid takes place alternatingly. Only in the event of a malfunction, i.e. when no liquid hydrogen H2 is discharged for a longer period of time, does the nitrogen N2 evaporate and is blown off into the environment 23.

The filling level of the storage container 1 with liquid hydrogen H2 can be significantly increased compared to a storage container without such a latent heat store 19 so that a larger mass of hydrogen H2 can be stored with the same installation space (footprint) for the storage container 1. The compact design of the storage container 1 achieved in this way can be particularly advantageous for use on ships in which a system for liquid hydrogen H2 is retrofitted. The latent heat store 19 makes possible, in particular, an emergency cooling of the shield 15 and therefore also of the storage container 1.

FIG. 4 shows a schematic block diagram of an embodiment of a method for operating the storage container 1.

In the method, in a step S1, a part of the liquid hydrogen H2 is discharged from the storage container 1 via the discharge line 22. During step S1, the nitrogen N2 held in the latent heat store 19 undergoes a phase transition from liquid to solid with the aid of a transfer of heat Q from the nitrogen N2 to the hydrogen H2. In the event that the nitrogen N2 is already solid, the nitrogen N2 remains solid during step S1.

In a step S2, the step S1 is ended. This means that no more hydrogen H2 flows through the discharge line 22. Step S2 can be carried out until all the nitrogen N2 has melted. During step S2, the nitrogen N2 therefore undergoes a phase transition from solid to liquid.

In a step S3 which is preferably carried out parallel to the steps S1, S2, the latent heat store 19 is fluidically separated from the environment 23 of the storage container 1. The fluidic separation of the latent heat store 19 from the environment 23 is only stopped when the nitrogen N2 is at least partially gaseous and too high a pressure builds up in the latent heat store 19. This can happen during a malfunction. When the maximum permissible pressure within the latent heat store 19 is reached, the gaseous nitrogen N2 is then released into the environment 23 via the blow-off line 24 and the blow-off valve 25.

During step S2, the heat Q required for the phase transition of the nitrogen N2 from solid to liquid is extracted from the shield 15 surrounding the inner container 3 of the storage container 1. This cools the shield 15.

In particular, steps S1 to S3 are only carried out during normal operation of the storage container 1, with the blow-off valve 25 of the storage container 1 only being opened during a malfunction of the storage container, whereby gaseous nitrogen N2 is blown off into the environment 23.

Although the present invention has been described with reference to embodiments, it can be modified in many ways within the scope of the claims.

### REFERENCE SIGNS USED

1 Storage vessel
2 Center axis
3 Inner container
4 Base section
5 Cover section
6 Cover section
7 Gas zone
8 Liquid zone
9 Phase boundary
10 Outer container
11 Base section
12 Cover section
13 Cover section
14 Gap
15 Shield
16 Base section
17 Cover section
18 Cover section
19 Latent heat store
20 Heat conduction element
21 Heat exchanger
22 Discharge line
23 Environment
24 Blow-off line
25 Blow-off valve
26 Interior space
27 Knitted fabric
28 Insulation element
29 Aluminum foil
30 Glass paper
g Direction of gravity
H2 Hydrogen/cryogen
N2 Nitrogen/phase-change material
Q Heat
S1 Step
S2 Step
S3 Step

1. A storage container for storing a cryogen, with an inner container for receiving the cryogen, a latent heat store for receiving a phase-change material, and a discharge line for removing only the liquid phase of the cryogen-from the inner container, wherein the discharge line is operatively connected to the latent heat store in such a way that liquid cryogen received in the discharge line exchanges heat with the phase-change material, and wherein the latent heat store can be fluidically connected to an environment of the storage container exclusively with the aid of a blow-off line.

2. The storage container according to claim 1, wherein the discharge line is routed through the latent heat store

3-15. (canceled)

16. The storage container according to claim 1, wherein a heat exchanger is attached to the discharge line which is arranged within the latent heat store.

17. The storage container according to claim 1, wherein the latent heat store is at least partially filled with a heat-conducting, fluid-permeable material structure, in particular a knitted fabric.

18. The storage container according to claim 1, wherein the blow-off line has a blow-off valve for blowing off the phase-change material into the environment.

19. The storage container according to claim 1, further comprising a shield which encloses the inner container and the latent heat store, wherein the latent heat store is thermally conductively connected to the shield.

20. The storage container according to claim 19, wherein the latent heat store is arranged between a cover section of the inner container and a cover section of the shield.

21. The storage container according to claim 19, wherein the blow-off line is thermally conductively connected to the shield.

22. The storage container according to claim 21, wherein the blow-off line runs helically around the shield on the inside or outside.

23. The storage container according to claim 19, further comprising an outer container that encloses the shield.

24. The storage container according to claim 23, further comprising a multi-layer insulation element which at least partially fills a gap provided between the inner container and the outer container.

25. The storage container according to claim 24, wherein the shield is embedded in the insulation element.

26. A method for operating a storage container according to claim 1 for storing a cryogen, having the following steps:
a) removing liquid cryogen from the storage container, wherein during step a), a phase-change material held in a latent heat store of the storage container is subjected to a phase transition from liquid to solid with the aid of a transfer of heat from the phase-change material to the liquid cryogen, or wherein the phase-change material remains solid during step a),
b) ending step a), wherein the phase-change material undergoes a phase transition from solid to liquid, and
c) fluidically separating the latent heat store from an environment of the storage container during steps a) and b).

27. The method according to claim 26, wherein during step b), heat (Q) required for the phase transition is extracted from a shield enclosing an inner container (3) of the storage container.

28. The method according to claim 26, wherein steps a) to c) are carried out during normal operation of the storage container, and wherein a blow-off valve of the storage container is opened exclusively in the event of a malfunction of the storage container, whereby gaseous phase-change material is blown off into the environment.

29. The method according to claim 27, wherein steps a) to c) are carried out during normal operation of the storage container, and wherein a blow-off valve of the storage container is opened exclusively in the event of a malfunction of the storage container, whereby gaseous phase-change material is blown off into the environment.
